(19) United States
(12) Patent Application Publication
(10) Pub. No.: US 2024/0301903 A1
(43) Pub. Date: Sep. 12, 2024

(54) Method for Joining Components, and Component Connection

(71) Applicant: Bayerische Motoren Werke Aktiengesellschaft, Muenchen (DE)

(72) Inventors: Manuel ANASENZL, Mainburg (DE); Andreas BRENNINGER, Geisenhausen (DE); Christian HAGEN, Landshut (DE); Joachim MEESS, Ergoldsbach (DE); Klaus SAMMER, Malgersdorf (DE); Reinhard WEINDL, Schoenberg (DE)

(21) Appl. No.: 18/282,077

(22) PCT Filed: Apr. 13, 2022
(86) PCT No.: PCT/EP2022/059820

§ 371 Date: Sep. 14, 2023

(30) Foreign Application Priority Data
Apr. 30, 2021 (DE) 10 2021 111 205.2

(51) Int. Cl. F16B 5/08; B23K 26/21; B23K 26/244; B23K 103/10; F16B 11/00

(52) U.S. Cl. CPC F16B 5/08; B23K 26/21; B23K 26/244; F16B 11/006; B23K 2103/10

(57) ABSTRACT

Methods and apparatuses for joining components are provided. A first component, such as a diecast aluminium component is provided having a joining region configured to arrange and fasten a second component. An adhesive layer is produced along the joining region via a thermal spaying process such as cold gas dynamic spraying. The second component is fastened to the adhesive layer by joining via laser welding using energy input indirectly via the second component.

### BACKGROUND AND SUMMARY OF THE INVENTION

The present subject matter relates to a method for joining components and to a component connection as is used for example in bodywork/vehicle construction.

In bodywork construction, steel/aluminum connections are used so as to keep down the weight of components, structural parts, and structures, etc. Customary joining or connecting methods in this context are riveting, more particularly (semi-tubular) self-piercing riveting, clinching, (flow-drilling) screwing, adhesive bonding, or combinations of these methods. A feature common to the aforesaid methods is that in terms of cycle time and costs they do not represent an optimum. For generation of sufficiently stiff and strong connections, moreover, the construction cost and complexity are often high.

It is therefore an object of the present subject matter to specify a method for joining components, and a component connection, which with optimized cycle times and optimized costs satisfy the most exacting mechanical requirements.

In accordance with the present subject matter, a method for joining components comprises the following steps of providing a first component, more particularly a diecast aluminum component, the first component having a joining region for the arrangement and securement of a second component; generating, at least regionally, an adhesion layer along or on the joining region by means of a thermal spraying method, more particularly gas dynamic cold spraying; securing the second component on the adhesion layer by joining by means of laser welding by energy input indirectly via the second component, for example.

The thermal spraying method is a surface coating method. It involves the molten removal, incipient melting or melting of additive materials, referred to as spraying additives, within or outside a spraying burner, and their acceleration in a gas stream in the form of sprayed particles. The component surface is not incipiently melted here. The result is a low thermal load. A layer is formed because the sprayed particles when they strike the component surface are flattened to a greater or lesser extent, dependent on process and on material, remain adhering primarily as a result of mechanical interlocking, and build up the sprayed layer/adhesion layer in a layer-by-layer manner. Serving as energy sources for the melting or incipient melting of the spray additive material are an electric arc (arc spraying), plasma jet (plasma spraying), oxygen-fuel flame or high-velocity oxygen-fuel flame (conventional and high-velocity flame spraying), rapidly preheated gases (gas dynamic cold spraying), and laser beam (laser beam spraying).

Gas dynamic cold spraying has proven presently to be a particularly advantageous coating method. According to one preferred example, it is operated with gas jet temperatures upward of 800° C. Preferred maximum temperatures are in the region of 1200° C., thus producing overall a preferred temperature range of between about 800° C. or 850° C. and about 1200° C. Trials have shown that temperatures in the region of about 1000° C. are optimal for coating quality. Via gas dynamic cold spraying, it is possible with advantage to achieve surfaces which have an optimal structure for the downstream joining processes.

According to one preferred example, the surface of the adhesion layer has an Sa value of preferably >5 μm, more preferably between 5 and 35 μm, and especially preferably between 5 and 15 μm. The Sa value (mean arithmetic height) is the amount of the height difference of a given point in comparison to the arithmetic mean of the surface.

The Sdr value of the adhesion layer is preferably at least 5%, more preferably in a range of 5-30%, and especially preferably about 12-20%. This parameter is the percentage of the additional area of the definition region that is attributable to the surface nature of the adhesion layer, in comparison to the absolutely planar definition region. The Sdr value of an untreated diecast (aluminum) component, for example, is in a region of a good 2%.

Laser welding or laser beam welding is a welding method in which the energy is supplied via a laser. With laser welding, advantageously, high welding speeds and also narrow and slender weld seam shapes may be realized. Moreover, the thermal warpage can be kept low in comparison to other welding methods. Equipment wear as well is very low relative to other welding methods, since, for example, there is no need for electrodes to be reworked or replaced, etc.

The first component, according to preferred examples, is a cast component, a panel and/or else a profile, preferably composed of a light metal, such as an aluminum material. Preferred cast components, but also second components, are structural components in particular, such as spring supports, side beams or cast nodes (e.g., the A pillar of a motor vehicle). In addition, cast components of the type in question, but also second components, may be complete frames, rear ends or front ends of motor vehicles. First and/or second components may be housings of electrical energy stores, more particularly high-voltage storage housings, especially preferably top parts or bottom parts of such housings.

The second component, according to one preferred example, is a component produced in a steel material. With advantage, the application of the adhesion layer allows different materials or materials not of the same kind to be connected. In particular, it enables, in a way which is low in cost and complexity, a welded connection between an aluminum component and a steel component, for example. The material employed for the adhesion layer is advantageously a steel material or an iron/steel-based material. According to one preferred example, the material used for the adhesion layer is an austenitic (stainless) steel and especially preferably a ferritic (stainless) steel. Presently provided with the adhesion layer, especially preferably, is a cast component made of an aluminum material, more particularly a diecast aluminum component.

Advantageously, according to one example, the energy is introduced indirectly via the second component. This has the advantage of largely avoiding the introduction of heat into the aluminum material and/or the introduction of heat into the first component. It is possible consequently and advantageously to prevent the formation of intermetallic phases in the first component.

According to one example, the method comprises the step of control of the energy input during welding in such a way that the first component is not melted or incipiently melted.

According to one preferred example, the laser welding takes place with robot assistance. Presently, at least one correspondingly designed welding robot is preferably employed. In this case, the welding parameters can be adapted to meet the requirements by way of the robot control.

According to one preferred example, the method comprises the step of through-welding through the second component.

According to one example, the welding takes place in such a way that welding occurs into or onto the adhesion layer through the second component.

According to one example, the method comprises the step of lengthwise welding along the second component.

In this case, fillet weld seams are usefully formed.

It may be mentioned at this point that, presently, not only welding with additive material but also welding without additive material may be employed.

In principle, laser welding offers very high degrees of freedom in relation to the weld seam shapes. The seam shapes may be designed freely within certain limits. According to preferred examples, the weld seams are circular, horseshoe-shaped, linear and/or undulating.

Securement takes place usefully by means of spot and/or seam welding.

According to one example, for example, stitch weld seams are used. Alternatively, however, spot welding is also possible. According to one preferred example, the weld spots have a distance along the joining region of around 15 to 25 mm, more particularly of about 20 mm.

Laser welding offers the advantage here over conventional resistance spot welding that in the case of laser welding the thickness of the adhesion layer may be significantly lower. A nugget, of the kind which occurs in the case of resistance spot welding, requires a thicker adhesion layer than is the case with laser welding. Moreover, the distancing of the weld spots can be more variable, since in contrast to what is the case with resistance spot welding, for example, there is no risk of shunts.

According to one preferred example, the adhesion layer has a thickness of not more than 1500 μm. Preferred thicknesses are in a range from 100 μm to 1000 μm, and the aforesaid upper limit is advantageously even lower—for example, 900 μm, 800 μm, and even lower. The aforesaid values are valid for adhesion layers which have an at least substantially constant thickness along the joining region.

The width of the adhesion layer, measured transverse to the joining region, according to preferred examples, is in a range from 5 to 40 mm, more preferably about 10 to 30 mm. The length of a region of increased layer thickness is preferably in a range from 5 to 40 mm, more preferably about 10 to 30 mm. The width of the joining region typically corresponds at least approximately to the width of the adhesion layer.

In the joining region, the components are usefully positioned or at least contacted indirectly via the adhesion layer. With advantage, the adhesion layer may at least regionally or sectionally be such that the two components are fixed in an intended position relative to one another. For this purpose, one or more stops or holding lugs may be formed on the adhesion layer, being designed for the form-fitting positioning of the components relative to one another.

Usefully, prior to welding, the two components are contacted indirectly via the adhesion layer, regionally or preferably completely. Particularly in the case of very large components, any minor dimensional differences affecting the first component (and/or else the second component) may be compensated for via local adaptation of the thickness of the adhesion layer, especially, for example, if this component exhibits warpage.

According to one example, the method comprises the step of contacting the components by uni- or bilateral force introduction into the joining region or, in particular, into the adhesion layer.

The force is introduced, according to one preferred example, directly via the laser welding robot. Force introduction takes place preferably directly before and/or during the energy input for welding. According to one example, the welding apparatus comprises a C clamp via which a force can be introduced onto or into the joining region from both sides. The force is alternatively introduced only from one side. In that case, either no further support is necessary from the other side, since the component itself, more particularly the first component, is sufficiently stiff, or it is supported via a corresponding apparatus which is arranged correspondingly.

The welding apparatus usefully comprises stop elements which are intended and designed for force introduction, and also means for generating the welded connection. Having proven advantageous presently is a configuration in which the means for generating a welded connection are positioned between two stop elements. The region to be welded can therefore be reliably contacted. Force introduction in this case takes place initially from one side. Alternatively, however, the welding apparatus may also be designed as a C clamp, enabling force introduction from both sides.

According to one example, the method comprises the step of remote laser welding with optical or tactile seam tracking.

In the case of remote or scanner welding, the laser beam is positioned via deflecting mirrors. Optical or tactile systems are used preferably for seam tracking.

According to one example, the adhesion layer has a different thickness along the joining region. In other words, the thickness of the adhesion layer varies along the joining region. The adhesion layer advantageously has profiling or structuring, comprising a sequence of repeating regions of higher layer thickness and lower layer thickness. According to one example, the adhesion layer may be formed intermittently, in other words only sectionally, along the joining region.

The method usefully comprises the step of welding in the region of increased layer thickness or only where an adhesion layer is formed.

According to one example, the profiling or structuring of the adhesion layer along the joining region is designed in such a way that the thickness of the adhesion layer in the region of a weld spot or of a weld seam is in a range from about 300 μm to about 1500 μm, more preferably in a range from about 350 μm to 1200 μm, and especially preferably in a range from about 400 μm to 800 μm.

A region of increased layer thickness is presently also called a wave crest; a region of reduced (or absent layer thickness) a wave trough.

The adhesion layer preferably has wave crests and wave troughs in alternation, at preferably regular distances, along the joining region. The distance, more particularly regular distance, between the wave crests, based on their center point, according to preferred examples is in a range from about 10 to 70 mm, especially preferably in a range from about 15 to 60 mm. According to one preferred example, the distance is about 20 mm. This distance has proven advantageous in bodywork and vehicle construction for the purpose of achieving mechanical objectives.

According to one preferred example, the height of a wave crest to the height of a wave trough is in a range from about 1.05 to 2.7, more preferably in a range from about 1.1 to 1.9, and very particularly preferably about 1.3 to 1.6, more particularly about 1.4 to 1.45.

According to one preferred example, the profiling or structuring of the adhesion layer is achieved by way of an adapted advancement speed during coating. For this purpose, the speed of travel is reduced to generate a region of increased layer thickness, while it is increased to generate a region of reduced layer thickness.

According to one example, a round nozzle is employed to generate the adhesion layer. Alternatively, a nozzle geometry is used which has a rectangular cross section. The nozzle in this case is aligned in such a way that the long side of the rectangle is oriented transversely to the advancement direction. The width of the rectangle determines the width of the adhesion layer. An advantage of this approach is that it is not necessary to operate in multiple tracks, as is the case with a round nozzle. In both cases, the adhesion layer may comprise two or more layers.

According to one example, the adhesion layer is generated in one overpass. Alternatively, two or more overpasses are needed. The adhesion layer is built up in thickness direction, i.e., optionally, in layers.

In principle, the adhesion layer may comprise multiple layers. The layers may be applied or generated in multiple overpasses. The layers may comprise or consist of different materials.

According to one example, the method comprises the step of passing over the joining region spirally or circularly to generate the adhesion layer.

With advantage, a circular movement is overlaid on an advancement movement of the coating tool along the joining region. This produces a spiral movement pattern. It has emerged that this technique, in combination with thermal coating/spraying methods, presently with gas dynamic cold spraying, affords very good qualitative results in conjunction with high and extremely high economy. A round nozzle is used advantageously in this case.

As already mentioned, according to one example, a flat nozzle may also be used. This offers the advantage that it is not necessary to place multiple tracks alongside one another in order to generate a joining region of a certain width. The movement pattern is therefore much simpler. When a round nozzle is used, alternatively to the spiral pass, the adhesion layer may be generated by a meandering pass over the joining region. In this case, the tool is passed over the joining region up to a point (turning point), before a new track is then placed alongside the track already produced, and so on.

It may be mentioned at this point that the adhesion layer, according to one example, has a different thickness transversely to the joining region. According to one example, the adhesion layer in cross section has a (slightly) bulging, convex design. According to one example, the adhesion layer in cross section has a planar or substantially planar middle region of increased thickness, which declines in the form of ramps to both sides, transversely to the joining region. Ways of generating the aforesaid geometries may include spiral passing. Along the joining region, the thickness/cross section of the adhesion layer in this case is preferably constant. Based on the cross section, welding takes place preferably in the middle or approximately in the middle. The edges or edge regions may but need not be used for application of adhesive, on one or both sides.

According to one example, the method comprises the steps of generating the adhesion layer by means of a thermal spraying method, more particularly gas dynamic cold spraying, and applying a functional layer to the adhesion layer, preferably by means of a thermal spraying method, more particularly likewise by means of gas dynamic cold spraying.

The functional layer is formed preferably as an anticorrosion layer. For this purpose, zinc or a zinc compound is provided preferably as material. The functional layer is usefully a zinc layer.

Alternatively, for corrosion protection, the adhesion layer or the first component as such is oiled.

According to one example, an intermediate layer is formed between the adhesion layer and the first component. The intermediate layer may likewise be generated via a thermal spraying method, such as gas dynamic cold spraying in particular. The intermediate layer is preferably designed to avoid contact corrosion between the first component and the adhesion layer. The entrainment of iron (Fe) into the aluminum material (Al) is preferably avoided, thus making it possible to avoid Fe—Al phases which are unfavorable because they are brittle.

According to one example, the method comprises the step of securing the second component on the adhesion layer and/or on the joining region additionally by joining by means of adhesive bonding.

According to one example, a one-component adhesive or a two-component adhesive is used. Preferred for use are structural adhesives. The one-component adhesive needs heat to cure. After welding, this adhesive is not cured. Instead, it may cure in a downstream painting process, for example. A two-component adhesive cures in air. The flexibility in terms of the material for use permits high degrees of freedom for the design of the components, in particular.

According to one example, the method comprises the steps of providing a first component having a surface treatment; and regionally removing the surface treatment by and during the generation of the adhesion layer.

A surface treatment of the type under discussion may be a CDP layer (cathodic dip painting), a passivation or, for example, a laser cleaning or laser activation of the component surface. It has emerged that the aforesaid kinds of “coatings” may be removed or ablated via the thermal spraying method. In other words, a surface treatment of whatever kind does not “interfere” with the application of the adhesion layer; also having an effect at this point are the preferably high gas temperatures of 800° C., especially preferably about 1000° C., of the gas jet, especially in the case of gas dynamic cold spraying.

Alternatively, the initially at least partly bright or uncoated components are joined and only subsequently supplied to a coating method, the latter serving the purpose of corrosion control, for example. According to one example, the method comprises the step of applying a surface treatment to the first component after the joining of the components.

According to one preferred example, the method comprises the step of bonding in the region of reduced layer thickness of the adhesion layer.

The joining region is presently that region in which the two components overlap. Correspondingly, the joining region may also be seen as a flange or flange portion or flange region. The joining region according to one example is an area which has a certain width and certain length. The adhesion layer is usefully applied over the full area or else only sectionally to this area. Alternatively, and more preferably, the joining region has an elongate extent, thus being significantly longer than it is wide. The adhesion layer may extend around or along the entire joining region. Alternatively, only regions or parts of the joining region are provided with the adhesion layer.

Where only regions of the joining region are provided with the adhesion layer, this means, for the application of the adhesive, that the adhesive may also be arranged in such a way that it directly connects the first and second components.

With particular preference, the adhesive is applied in such a way that it also contacts the adhesion layer, thus providing a connection between the adhesion layer and the second component. This is particularly advantageous since by virtue of the process, the adhesion layer has a roughness which is optimal for the adhesion of the adhesive (in this regard, see the characteristic roughness values already stated). The roughness or the resultant increase in surface area offers ideal conditions for the use of adhesives.

For the use of adhesive, there is particular advantage to an adhesion layer which has wave crests and wave troughs, since the wave troughs are able optimally to serve as reservoirs of adhesive. Via the thickness of the adhesion layer in the region of the wave troughs, therefore, it is possible with advantage to establish an optimal thickness of the layer of adhesive in these regions. According to preferred examples, the thickness of the layer of adhesive is about 200 μm to 400 μm, more particularly about 300 μm. This may be realized advantageously by way of the ratio of the height of the wave crests to the wave troughs. According to one example, the method comprises the step of applying adhesive before or after welding.

According to one example, the adhesive is applied locally to the wave crests. In this case, a corresponding amount of adhesive is applied advantageously to the wave crests. The adhesive is preferably applied linearly and continuously along the adhesion layer. In this case, preferably, the travel speed in the region of the wave troughs is slowed down, since here, usefully, more adhesive is held available.

As viewed along the joining region, the adhesive seam according to one example is configured such that it completely seals off the joining region toward one side (K1 adhesive seam). Alternatively, the adhesive seam or two or more adhesive seams is or are arranged in such a way that the joining region is sealed off completely toward both sides (K2 adhesive seam). Usefully, and according to one preferred example, the adhesion layer is completely embedded in adhesive, in other words being encapsulated in or into the adhesive.

The present subject matter also relates to a component connection, comprising a first component, more particularly composed of an aluminum material, and a second component, more particularly composed of a steel material, which are secured to one another along a joining region, the first component in the joining region at least regionally having an adhesion layer generated by means of a thermal spraying method, and the second component being secured to the adhesion layer by means of laser welding. The first component, composed of an aluminum material, is advantageously provided, by means of the spraying method, with a steel coating/adhesion layer in order subsequently to be connected by means of laser welding to the second component, usefully composed of steel. With particular preference, the first component is a diecast aluminum component. This component may have a surface treatment, such as a CDP coating, a passivation or a laser activation/laser cleaning, etc.

According to one preferred example, the adhesion layer extends along the preferably elongate joining region and along the joining region it has profiling, structuring or undulation—cf. the aforementioned wave crests/wave troughs—with preferably at least one weld spot or weld seam being formed at each of the wave crests. The adhesion layer preferably has wave crests and wave troughs in alternation along the joining region, with the weld spot or at least one weld spot being arranged at the wave crests. Additionally, or alternatively, weld seams, more particularly stitch weld seams, may also be formed at the wave crests. Here, laser welding advantageously enables a free seam design.

Moreover, the advantages and features mentioned in connection with the method are valid analogously and correspondingly for the component connection, and vice versa.

Further advantages and features are apparent from the description hereinafter of examples of the method and, respectively of component connections, with reference to the appended figures.

### BRIEF DESCRIPTION OF THE DRAWINGS

FIG. 1 shows a schematic view of one example of a component connection;

FIG. 2 shows a further schematic view of one example of a component connection;

FIG. 3 shows a further schematic view of one example of a component connection;

FIG. 4 shows a further schematic example of a component connection;

FIG. 5 shows a section through a joining region, as drafted in FIG. 4;

FIG. 6 shows examples of methods for generating the adhesion layer.

### DETAILED DESCRIPTION

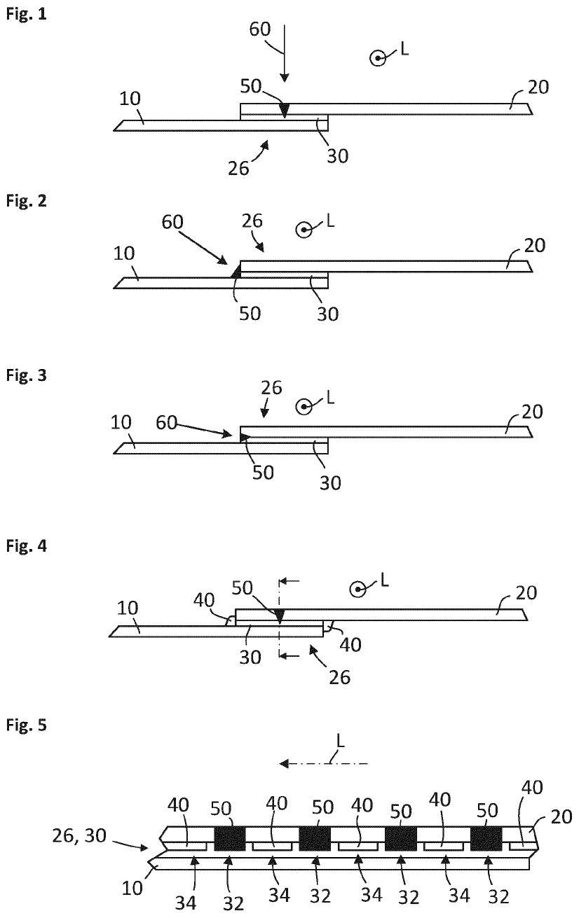

FIG. 1 in a schematic view shows a first component 10, on which an adhesion layer 30 is arranged, preferably by means of gas dynamic cold spraying. Secured by material bonding on this adhesion layer 30 is a second component 20, which here, according to one preferred example, is a steel component, the securement being achieved by means of laser welding—cf. the welded connection 50. Reference sign 20 indicates, schematically, the direction of an energy beam or of energy input for generating the weld seam or welded connection 50. The two components 10 and 20 overlap along a joining region 26. Presently, the energy is usefully introduced indirectly via the second component 20. The laser welding method is usefully performed in such a way that the first component 10 is not melted and/or incipiently melted. In particular, laser welding permits a very gentle welding method with a minimal input of energy into the first component 10. For orientation, a longitudinal direction L is outlined, along which the joining region 26 or the adhesion layer 30 extends. FIGS. 2 to 4 draft further possible designs of such a connection.

FIG. 2 shows a welded connection 50 formed substantially as a fillet weld seam. In this case, for example, lengthwise welding takes place along the second component 20. In principle it may be mentioned that presently and preferably both spot welding and seam welding are carried out. Laser welding affords the advantage that the component connection or the joining region need only be accessible from one side. The components 10 and 20 are usefully contacted with one another prior to welding; this may likewise take place by force introduction either from one side or from two sides.

FIG. 3 shows a further design of a possible component connection, the welded connection in this case being arranged laterally. The designs of welded connections 50 as are shown in FIGS. 1 to 3 may be combined arbitrarily as part of the production of a component connection.

FIG. 4 shows substantially the draft from FIG. 1, with the adhesion layer 30 here being embedded laterally by adhesive 40, in other words encapsulated. Accordingly, it is not only possible to boost the strength of the connection, but the corrosion control as well can be increased. The adhesion layer 30 may be protected against corrosion by way of the layers of adhesive 40.

FIG. 5 shows a further example of a component connection, with a section being outlined along a joining region 26 as indicated via the section line in FIG. 4. It can be seen that an adhesion layer 30 presently has different thickness regions—cf. the wave crests 32 and also the wave troughs 34. In other words, along the longitudinal direction L, the adhesion layer 30 has a different thickness. The adhesion layer 30 is usefully welded to a second component 20 in the region of the wave crests 32. The welded connections 50 are presently drafted as stitch weld seams. In between them, in other words in the wave troughs 34, adhesive 40 is usefully provided, and additionally, advantageously strengthens the component connection. The use of adhesive 40 in this context is particularly favorable, since the adhesion layer 30 has a roughness which is optimal specifically for the adhesion of the adhesive 40. Moreover, via the height of the wave troughs 34 or the height of the intermediate spaces, the thickness of the layer of adhesive can be adjusted precisely to an optimal degree. Stitch weld seams of these kinds may be achieved with suitable laser welding tools, including laser welding tongs (C clamps), which at the same time enable introduction of force into the two components 10 and 20. Presently, advantageously, laser spot welding is carried out as well. In that case, usefully, in the region of the wave crests 32, at least one laser weld spot is arranged or provided in each case.

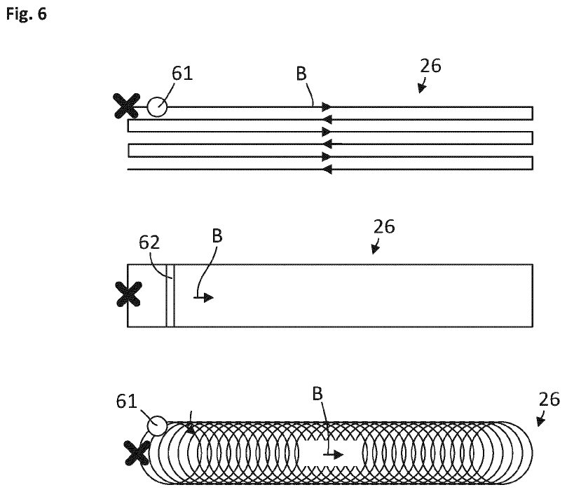

FIG. 6 shows a meandering pass over the joining region 26 for the purpose of generating an adhesion layer. The cross marks a starting point; a movement direction of a round nozzle 61 is drafted via the arrows B.

The adhesion layer may also be generated by means of a flat nozzle 62, as drafted in the second image. In this case, the track need only be passed over once.

In the present case, a spiral/circular movement direction has proven advantageous, as indicated in the last draft. Here as well, a round nozzle 61 is advantageously employed. The movement pattern is more complex, but low process times can be realized and there is no need for masking. Moreover, the width of the adhesion layer, in contrast to what is the case when using a flat nozzle, for example, can be adapted in line with requirements.

### LIST OF REFERENCE SIGNS

10 first component
20 second component
26 joining region
30 adhesion layer
32 wave crest, plateau
34 wave trough
40 (layer of) adhesive
50 welded connection
60 energy beam/laser beam
61 round nozzle
62 flat nozzle
B movement direction
L longitudinal direction

1.-15. (canceled)

16. A method for joining components, comprising:
providing a diecast aluminum component having a joining region configured to arrange and secure a second component;
generating an adhesion layer along or on the joining region using gas dynamic cold spraying; and
securing the second component on the adhesion layer by joining using laser welding.

17. The method according to claim 16, further comprising:
controlling of an energy input during welding such that the diecast aluminum component is not melted or incipiently melted.

18. The method according to claim 16, further comprising:
through-welding through the second component.

19. The method according to claim 16, further comprising:
lengthwise welding on the second component.

20. The method according to claim 16, further comprising:
passing over the joining region spirally to generate the adhesion layer.

21. The method according to claim 16, further comprising:
further securing the second component via spot and/or seam welding.

22. The method according to claim 16, wherein
the components are positioned in the joining region over the adhesion layer.

23. The method according to claim 16, further comprising:
contacting the components by uni- or bilateral force introduction into the joining region.

24. The method according to claim 16, further comprising:
remote laser welding with optical or tactile seam tracking.

25. The method according to claim 16, wherein
a thickness of the adhesion layer varies along the joining region.

26. The method according to claim 25, further comprising:
welding in a region of increased layer thickness.

27. The method according to claim 16, further comprising:
securing the second component on the adhesion layer and/or on the joining region additionally by adhesive bonding.

28. The method according to claim 27, further comprising:
bonding in the region of reduced layer thickness.

29. The method according to claim 27, further comprising:
applying adhesive before or after welding.

30. A component connection comprising:
a first component composed of an aluminum material, and
a second component composed of a steel material, wherein
the first and second components are secured to one another along a joining region,
the first component in the joining region has an adhesion layer generated via a thermal spraying method, and
the second component is secured to the adhesion layer via laser welding.
